(19) United States
(12) Patent Application Publication
(10) Pub. No.: US 2013/0170724 A1
(43) Pub. Date: Jul. 4, 2013

(54) METHOD OF GENERATING ELASTICITY IMAGE AND ELASTICITY IMAGE GENERATING APPARATUS

(71) Applicant: SAMSUNG ELECTRONICS CO., LTD., Suwon-si (KR)

(72) Inventors: Sang-wook Kim, Seoul (KR); Na-hyup Kang, Seoul (KR); Kyung-hwan Kim, Yongin-si (KR); Do-kyoon Kim, Seongnam-si (KR); Tae-hyun Rhee, Yongin-si (KR)

(73) Assignee: SAMSUNG ELECTRONICS CO., LTD., Suwon-si (KR)

(21) Appl. No.: 13/720,237

(22) Filed: Dec. 19, 2012

(30) Foreign Application Priority Data
Jan. 4, 2012 (KR) 10-2012-0001144

(51) Int. Cl. G06T 15/00

(52) U.S. Cl. CPC G06T 15/00
USPC 382/131

(57) ABSTRACT

A method of generating an elasticity image and an elasticity image generating apparatus are provided. The method includes detecting corresponding partial areas from examined areas of a first elasticity image and a second elasticity image from among a plurality of elasticity images indicating elasticity of examined areas in a subject, and generating data of a third elasticity image, comprising combining data of the first elasticity image with data of the second elasticity image based on the corresponding partial areas of the first elasticity image and the second elasticity image.

### CROSS-REFERENCE TO RELATED APPLICATIONS

This application claims the benefit under 35 U.S.C. §119(a) of Korean Patent Application No. 10-2012-0001144, filed on Jan. 4, 2012, in the Korean Intellectual Property Office, the entire disclosure of which is incorporated herein by reference for all purposes.

### BACKGROUND

1. Field

The following description relates to methods of generating an elasticity image and elasticity image generating apparatuses.

2. Description of Related Art

Medical devices configured to create cross-sectional images showing internal structures in a human body, such as ultrasonic imaging devices, X-ray imaging devices, computed tomography (CT) devices, and magnetic resonance imaging (MRI) devices, have been developed to improve patient convenience and expedite disease diagnosis with respect to a patient.

By way of a probe, ultrasonic imaging devices transmit an ultrasound signal to a predetermined part in a human body from a surface of the human body. The devices obtain an image of blood flow or a section of a soft tissue in the human body based on information determined from an ultrasound echo signal reflected from the soft tissue. Such ultrasonic imaging devices display a reflection coefficient of the ultrasound echo signal as a brightness at each point on a screen to generate a two-dimensional (2D) brightness (B)-mode image. Ultrasonic imaging devices are small, display images in real time, and have no risk of X-ray radiation exposure.

Since an abnormal tissue, such as a tumor or a cancer, has a reflection coefficient similar to that of a normal tissue but has a degree of elasticity greater than that of the normal tissue, the abnormal tissue may be more accurately displayed based on an elasticity imaging technique that generates an elasticity image indicating elasticity of a tissue. Such an elasticity imaging technique may accurately detect a tissue, such as a cyst, having a degree of elasticity less than that of a normal tissue and a pathological tissue, such as a cancer, having a degree of elasticity greater than that of the normal tissue.

### SUMMARY

In one general aspect, a method of generating an elasticity image includes detecting corresponding partial areas from examined areas of a first elasticity image and a second elasticity image from among a plurality of elasticity images indicating elasticity of examined areas in a subject, and generating data of a third elasticity image, comprising combining data of the first elasticity image with data of the second elasticity image based on the corresponding partial areas of the first elasticity image and the second elasticity image.

The method may further include that the detecting of the corresponding partial areas includes detecting a feature value of a first partial area that is a portion of the examined area of the first elasticity image from the data of the first elasticity image, and detecting a second partial area corresponding to the first partial area from the examined area of the second elasticity image based on the detected feature value of the first partial area.

The method may further include that the detecting of the feature value includes converting elasticity values of pixels of the first elasticity image into differential values between the elasticity values of the pixels of the first elasticity image and elasticity values of adjacent pixels, and detecting differential values of pixels of the first partial area of the first elasticity image from among differential values of the pixels of the first elasticity image as feature values.

The method may further include that the detecting of the second partial area is based on the detected feature value of the first partial areas and a similarity of the second elasticity image.

The method may further include that the first partial area is determined based on a positional relationship between the examined area of the first elasticity image and the examined area of the second elasticity image.

The method may further include that the detecting of the corresponding partial areas includes converting elasticity values of pixels of the plurality of elasticity images into differential values to generate differential data of the plurality of elasticity images, detecting differential values of pixels of a first partial area that is a portion of the examined area of the first elasticity image from differential data of the first elasticity image as feature values, and detecting an area having a greatest similarity to a feature value of the first partial region from differential data of the second elasticity image as a second partial area of the second elasticity image corresponding to the first partial area of the first elasticity image.

The method may further include that a partial area of the differential data of the second elasticity image that allows a sum of errors between differential values of pixels of the first partial area from among the differential data of the second elasticity image and differential values of pixels of the partial area of the differential data of the second elasticity image to be equal to or less than a preset allowance error is detected as the second partial area.

The method may further include that the first elasticity image is combined with the second elasticity image by matching pixels of the corresponding partial areas of the first elasticity image and the second elasticity image to generate the data of the third elasticity image.

The method may further include that the generating of the data of the third elasticity image includes correcting the data of any one of the first elasticity image and the second elasticity image based on a correlation between features of the corresponding partial areas of the first elasticity image and the second elasticity image to obtain corrected data, and combining the corrected data obtained from any one of the first elasticity image and the second elasticity image with the data of an elasticity image that remains from the any one of the first elasticity image and the second elasticity image.

The method may further include that the correcting of the data of any one of the first elasticity image and the second elasticity image is based on a correlation obtained between features of elasticity values of pixels of the corresponding partial areas of the first elasticity image and the second elasticity image.

The method may further include that the correlation between the features of the elasticity values of the pixels of the corresponding partial areas of the first elasticity image and the second elasticity image is obtained from a ratio of analyzed averages of the elasticity values of the pixels of the corresponding partial areas of the first elasticity image and the second elasticity image.

The method may further include that the generated data of the third elasticity image indicates elasticity of an examined area including the examined area of the first elasticity image and the examined area of the second elasticity image.

The method may further include determining a position of an examined area of the third elasticity image in all areas of an elasticity image display device, and displaying the position of the examined area of the third elasticity image on the elasticity image display device.

In another general aspect, an elasticity image generating apparatus includes an image processor configured to detect corresponding partial areas from examined areas of a first elasticity image and a second elasticity image from among a plurality of elasticity images indicating elasticity of examined areas in a subject, and generate data of a third elasticity image by combining data of the first elasticity image with data of the second elasticity image based on the corresponding partial areas of the first elasticity image and the second elasticity image.

The apparatus may further include a storage unit configured to store therein information configured to detect the corresponding partial areas of the first elasticity image and the second elasticity image.

The apparatus may further include that the image processor includes a partial area detecting unit, a correcting unit, and a combining unit, the partial area detecting unit being configured to detect a feature value of a first partial area that is a portion of the examined area of the first elasticity image from the data of the first elasticity image, the partial area detecting unit being configured to detect a second partial area corresponding to the first partial area from the examined area of the second elasticity image based on the detected feature value of the first partial area, the correcting unit being configured to correct the data of any one of the first elasticity image and the second elasticity image based on a correlation between features of the corresponding partial areas of the first elasticity image and the second elasticity image to obtain corrected data, the combining unit being configured to combine the corrected data obtained from any one of the first elasticity image and the second elasticity image with the data of an elasticity image that remains from the any one of the first elasticity image and the second elasticity image.

The apparatus may further include that the partial area detecting unit is further configured to convert elasticity values of pixels of the first elasticity image into differential values between the elasticity values of the pixels of the first elasticity image and elasticity values of adjacent pixels, and detect differential values of pixels of the first partial area of the first elasticity image from among differential values of the pixels of the first elasticity image as feature values.

The apparatus may further include that the partial area detecting unit is further configured to detect as the second partial area of the second elasticity image a partial area of differential data of the second elasticity image that allows a sum of errors between differential values of pixels of the first partial area from among the differential data of the second elasticity image and differential values of pixels of the partial area of the differential data of the second elasticity image to be equal to or less than an allowance error.

The apparatus may further include that the correcting unit is further configured to correct the data of any one of the first elasticity image and the second elasticity image based on a correlation obtained by the correcting unit, the correlation being between features of elasticity values of pixels of the corresponding partial areas of the first elasticity image and the second elasticity image.

The apparatus may further include an ultrasound image data generating unit configured to generate brightness (B)-mode ultrasound image data, and an image combining unit configured to combine the B-mode ultrasound image data with the data of the third elasticity image to generate a combined ultrasound image.

In yet another general aspect, there is provided a computer-readable recording medium having embodied thereon a program configured to execute a method of generating an elasticity image, the method including detecting corresponding partial areas from examined areas of a first elasticity image and a second elasticity image from among a plurality of elasticity images indicating elasticity of examined areas in a subject, and generating data of a third elasticity image, comprising combining data of the first elasticity image with data of the second elasticity image based on the corresponding partial areas of the first elasticity image and the second elasticity image.

In still another general aspect, a method of generating an elasticity image includes detecting corresponding first and second partial areas based on data of a first elasticity image indicating elasticity of a first examined area in a subject and data of a second elasticity image indicating elasticity of a second examined area in the subject, the first partial area being a portion of an examined area of the first elasticity image, the second partial area being a portion of an examined area of the second elasticity image, and generating data of a third elasticity image, comprising combining the data of the second elasticity image with data of a corrected image obtained from the data of the first elasticity image.

Other features and aspects may be apparent from the following detailed description, the drawings, and the claims.

### BRIEF DESCRIPTION OF THE DRAWINGS

FIG. 1 is a block diagram illustrating an example of an elasticity imaging system.

FIG. 2 is a block diagram illustrating an example of an elasticity image generating device of the elasticity imaging system of FIG. 1.

FIG. 3 is a diagram illustrating an example of a case in which data of a third elasticity image is generated based on data of a first elasticity image and a second elasticity image of a plurality of elasticity images.

FIG. 4 is a flowchart illustrating an example of a method of generating an elasticity image.

FIG. 5 is a flowchart illustrating an example of the detecting of the corresponding partial areas according to the method of generating the elasticity image of FIG. 4.

FIG. 6 is a flowchart illustrating an example of the generation of third elasticity image data according to the method of generating the elasticity image of FIG. 4.

FIGS. 7A through 7C are diagrams illustrating examples of data of the first elasticity image of FIG. 3, data of the second elasticity image of FIG. 3, and data of the third elasticity image of FIG. 3, respectively.

FIGS. 8A and 8B are diagrams illustrating examples of differential data generated from the data of FIGS. 7A through 7C of the first and second elasticity images of FIG. 3, respectively.

FIG. 9 is a diagram illustrating an example configured to explain a method of determining a first partial area of the first elasticity image of FIG. 3.

FIGS. 10A through 10C are diagrams illustrating other examples of data of the first elasticity image, data of the second elasticity image, and data of the third elasticity image, respectively.

FIG. 11 is a block diagram illustrating another example of an elasticity imaging system.

FIG. 12 is a block diagram illustrating an example of an ultrasound image obtained by an image combining unit and displayed on an image display device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. In addition, descriptions of well-known functions and constructions may be omitted for increased clarity and conciseness. As used herein, the term “and/or” includes any and all combinations of one or more of the associated listed items.

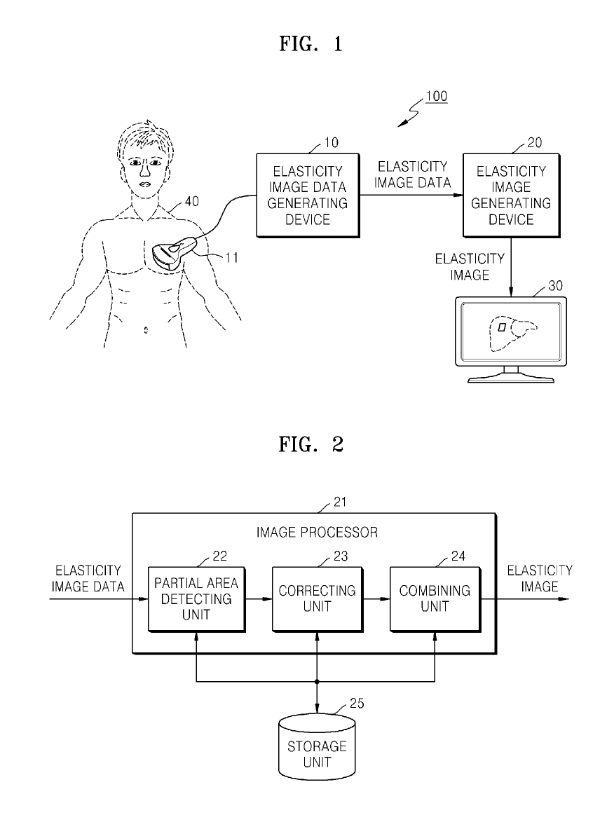

FIG. 1 is a block diagram illustrating an example of an elasticity imaging system 100. Referring to the example illustrated in FIG. 1, the elasticity imaging system 100 includes an elasticity image data generating device 10, an elasticity image generating device 20, and an elasticity image display device 30. Examples of the elasticity imaging system 100 may include an ultrasonic imaging system, a computed tomography (CT) system, and a magnetic resonance imaging (MRI) system. The elasticity imaging system 100 generates an image indicating elasticity of an examined area in a body of a patient 40 in order for a medical expert, such as a doctor, to perform a disease diagnosis based on internal structures of the body of the patient 40 displayed by the image.

The elasticity image data generating device 10 generates a source signal and transmits the source signal, via a probe 11 connected to the elasticity image data generating device 10, to an area of examination in the body of the patient 40. In this case, the source signal may be any of various signals known to one of ordinary skill in the art, such as an ultrasound signal and an X-ray signal.

The elasticity image data generating device 10 generates pieces of elasticity image data indicating elasticity of different examined areas in the body of the patient 40 based on a response signal from the probe 11. That is, as the medical expert moves the probe 11 in order to diagnose a disease of the patient 40, the elasticity image data generating device 10 sequentially generates pieces of elasticity image data indicating the elasticity of the different examined areas in the body of the patient 40.

In an example, the elasticity imaging system 100 generates an elasticity image based on a response signal obtained when the probe 11 contacting a surface of the body of the patient 40 repeatedly compresses and relaxes the body of the patient 40 to transmit and receive an ultrasound wave. In another example, the probe 11 includes transducers, each of which is configured to transmit and receive an ultrasound signal. Since the ultrasound signal causes a target tissue in the body of the patient 40 to be displaced, in yet another example, elasticity image data is generated by detecting information about the displacement of the target tissue due to the ultrasound signal based on a response signal to the ultrasound signal.

In an example, the examined area in the body of the patient 40 is a section or a portion of an organ, such as a liver or a kidney. Alternatively, in another example, the examined area in the body of the patient 40 is a section or a portion of a breast of a woman, a womb of a pregnant woman, amniotic fluid in a womb, or a section or a portion of an embryo. The elasticity image display device 30 displays an elasticity image received from the elasticity image generating device 20. Examples of the elasticity image display device 30 include a device known to one of ordinary skill in the art configured to display an elasticity image on a screen or paper, but are not limited thereto.

Elasticity image data generated by the elasticity image data generating device 10 is limited to a field of view that is visible to the probe 11, according to the characteristics thereof, at any one point in time. Here, the field of view refers to an area that may be viewed by the probe 11 when the probe 11 is resting at a predetermined position of the body of the patient 40. In an example, an ultrasonic version of the elasticity imaging system 100 generates a cross-sectional elasticity image of a section of a liver of a patient in real time.

FIG. 2 is a block diagram illustrating an example of the elasticity image generating device 20 of the elasticity imaging system 100 of FIG. 1. Referring to the example illustrated in FIG. 2, the elasticity image generating device 20 includes an image processor 21 and a storage unit 25. In an example, the elasticity image generating device 20 includes a user interface configured to receive a command or information from a user, such as a medical expert. In another example, the user interface is an input device, such as a keyboard or a mouse, or a graphic user interface (GUI) of the elasticity image display device 30. In addition, in yet another example, the elasticity image generating device 20 includes an input unit and an interface known to one of ordinary skill in the art. In this example, the input unit is configured to connect the elasticity image data generating device 10 and the image processor 21, the interface is an output unit configured to connect the image processor 21 and the elasticity image display device 30.

The image processor 21 receives pieces of elasticity image data indicating elasticity of different examined areas from the elasticity image data generating device 10, combines the received pieces of elasticity image data, and generates an elasticity image from the combined pieces of elasticity image data indicating elasticity of an examined area having a wider field of view. In an example, contiguously input pieces of elasticity image data from the received pieces of elasticity image data have a common examined area.

The image processor 21 includes a partial area detecting unit 22, a correcting unit 23, and a combining unit 24. In an example, the image processor 21 includes exclusive chips configured to perform functions of the partial area detecting unit 22, the correcting unit 23, and the combining unit 24, or exclusive programs stored in the storage unit 25 and a general-purpose central processing unit (CPU) configured to perform functions of the partial area detecting unit 22, the correcting unit 23, and the combining unit 24.

In an example, various pieces of data generated during an operation of the image processor 21 are stored in the storage unit 25. In another example, pieces of elasticity image data and elasticity image data generated by combining the pieces of elasticity image data are stored in the storage unit 25. In addition, in yet another example, pieces of information needed to combine the pieces of elasticity image data are stored in the storage unit 25. Examples of the storage unit 25 known to one of ordinary skill in the art include a hard disc drive, a read-only memory (ROM), a random access memory (RAM), a flash memory, and a memory card.

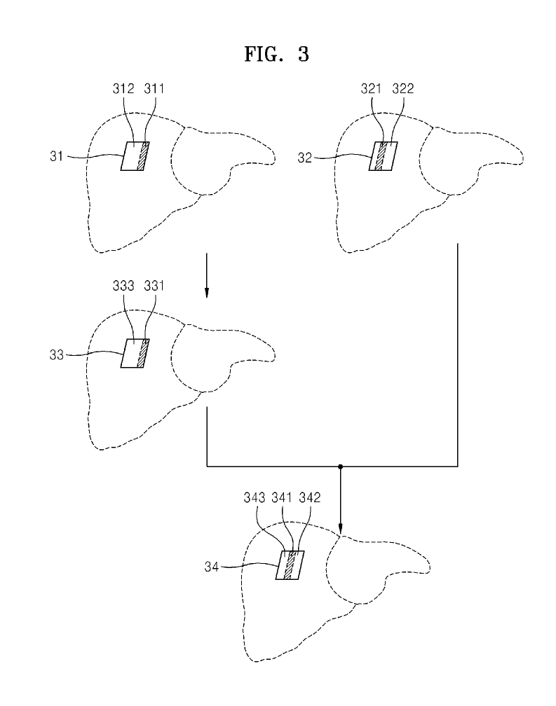

FIG. 3 is a diagram illustrating an example of a case in which data of a third elasticity image 34 is generated based on data of a first elasticity image 31 and a second elasticity image 32 of a plurality of elasticity images. Referring to the example illustrated in FIG. 3, the partial area detecting unit 22 of the image processor 21 detects corresponding first and second partial areas 311 and 321 from data of the first elasticity image 31 indicating elasticity of a first examined area in a subject and data of the second elasticity image 32 indicating elasticity of a second examined area in the subject, respectively. The partial area detecting unit 22 determines the first partial area 311 that is a portion of an examined area of the first elasticity image 31, and determines a second partial area 321 that is a portion of an examined area of the second elasticity image 32. In an example, the partial area detecting unit 22 determines the first partial area 311 based on a positional relationship between the examined area of the first elasticity image 31 and the examined area of the second elasticity image 32.

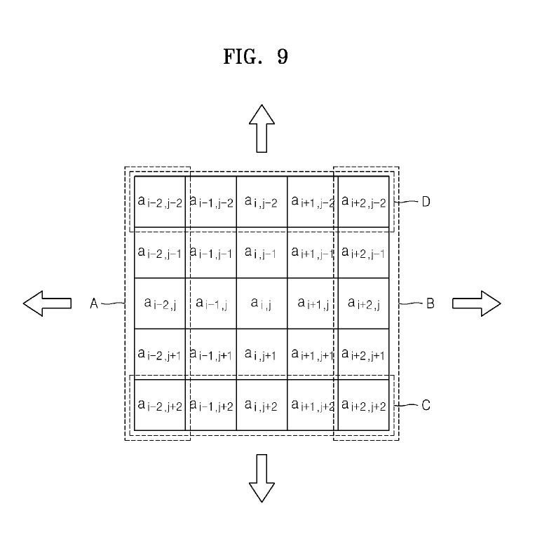

FIG. 9 is a diagram illustrating an example configured to explain a method of determining a first partial area 311 of the first elasticity image 31 of FIG. 3. Referring to the examples illustrated in FIGS. 3 and 9, when a medical expert diagnoses a disease of the patient 40 while moving the probe 11 rightward, the second elasticity image 32 is located at the right of the first elasticity image 31, and thus rightmost pixels B of the first elasticity image 31 are determined as the first partial area 311. If the second elasticity image 32 is located at the left of the first elasticity image 31, leftmost pixels A of the first elasticity image 31 are determined as the first partial area 311. If the second elasticity image 32 is located at the top of the first elasticity image 31, uppermost pixels D of the first elasticity image 31 are determined as the first partial area 311. If the second elasticity image 32 is located at the bottom of the first elasticity image 31, lowermost pixels C of the first elasticity image 31 are determined as the first partial area 311. In various examples, a positional relationship between the first elasticity image 31 and the second elasticity image 32 is detected by a sensor provided in the probe 11, or is determined by analyzing image information of the first elasticity image 31 and the second elasticity image 32.

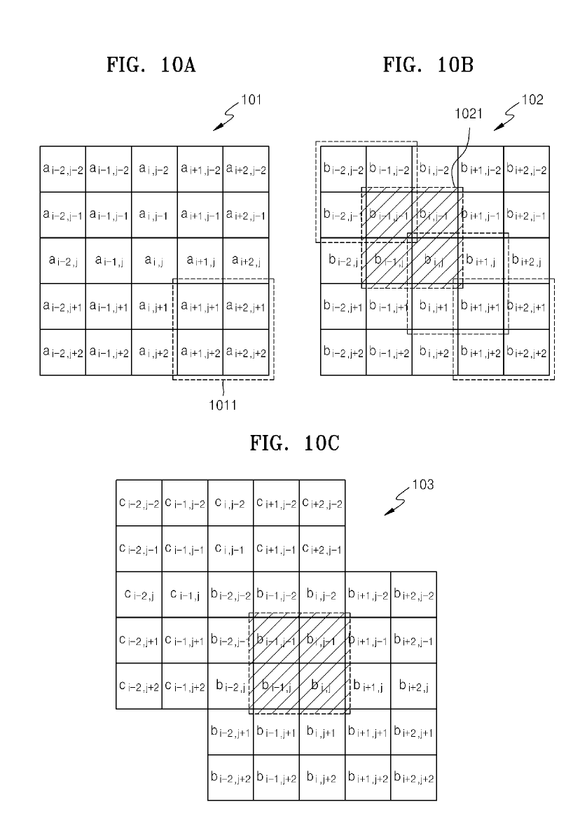

FIGS. 10A through 10C are diagrams illustrating examples of data 101 of the first elasticity image 31, data 102 of the second elasticity image 32, and data 103 of the third elasticity image 34, respectively. Referring to FIGS. 3 and 10A through 10C, if the data 102 of the second elasticity image 32 is located at the right and bottom of the data 101 of the first elasticity image 31, right and lower four pixels 1011 of the data 101 of the first elasticity image are determined as the first partial area 311.

In an example, the partial area detecting unit 22 detects the second partial area 321 corresponding to the first partial area 311 of the first elasticity image 31 from the examined area of the second elasticity image 32 based on a similarity of elasticity values of pixels of a partial area that is a portion of the examined area of the second elasticity image 32 and elasticity values of pixels of the first partial area 311 from the examined area of the first elasticity image 31. In an example of this case, a similarity of partial areas between the first and second elasticity images 31 and 32 is determined by comparing elasticity values of pixels of the first and second partial areas 311 and 321 of the first and second elasticity images 31 and 32 or feature values of pixels of the first and second partial areas 311 and 321 of the first and second elasticity images 31 and 32. In a further example of this case, the feature values refer to differential values between elasticity values of pixels of the first and second partial areas 311 and 321 and elasticity values of adjacent pixels.

The correcting unit 23 of the image processor 21 corrects data of the first elasticity image 31 based on a detection result of the partial area detecting unit 22. That is, the correcting unit 23 corrects data of the first elasticity image 31 based on a correlation between the first partial area 311 of the first elasticity image 31 and the second partial area 321 of the second elasticity image 32. In an example of this case, the correcting unit 23 corrects elasticity values of all pixels included in the first elasticity image 31 or pixels 333 corresponding to areas other than the first partial area from the data of the first elasticity image 31.

The combining unit 24 of the image processor 21 generates data of the third elasticity image 34 by combining data of the second elasticity image 32 with data of a corrected image 33 obtained from the data of the first elasticity image 31 based on a detection result of the partial area detecting unit 22. The combining unit 24 generates the third elasticity image 34 by combining the second elasticity image 32 with the corrected image 33 obtained from the first elasticity image 31 by matching pixels of partial areas 321 and 331 of the second elasticity image 32 and the corrected image 3, respectively. The third elasticity image 34 includes a combined area 343 obtained from a left area 333 of the first partial area 331 of the corrected image 33, and combined areas 341 and 342 obtained from the second partial area 321 and a right area 322 of the second elasticity image 32.

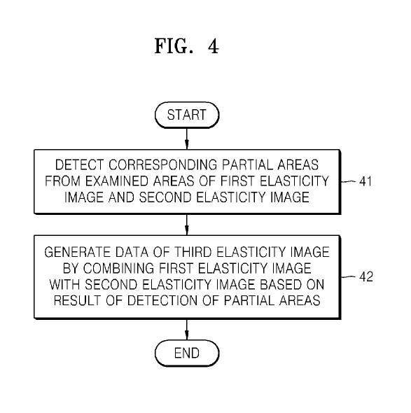

FIG. 4 is a flowchart illustrating an example of a method of generating an elasticity image. In an example, the method is performed by the partial area detecting unit 22, the correcting unit 23, and the combining unit 24 of the image processor 21. Referring to the examples illustrated in FIGS. 3 and 4, the image processor 21 detects (41) the corresponding first and second partial areas 311 and 321 from data of the first elasticity image 31 indicating elasticity of a first examined area in a subject and data of the second elasticity image 32 indicating elasticity of a second examined area in the subject. In an example of this case, matching points of the first elasticity image 31 and the second elasticity image 32 are based on the first and second partial areas 311 and 321 detected by the partial area detecting unit 22. The image processor 21 generates (42) data of the third elasticity image 34 by combining the data of the first elasticity image 31 with the data of the second elasticity image 32, based on a correlation between the first and second partial areas 311 and 321 of the first and second elasticity images 31 and 32, respectively.

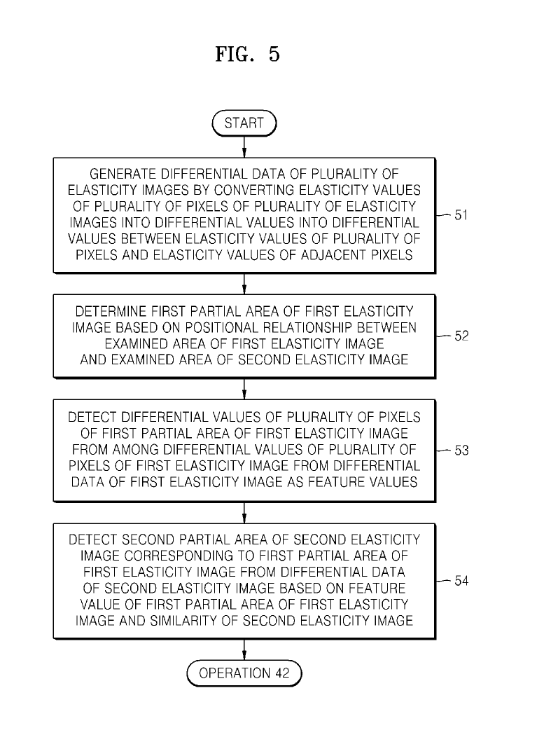

FIG. 5 is a flowchart illustrating an example of the detecting of the corresponding partial areas according to the method of generating the elasticity image of FIG. 4. Referring to the examples illustrated in FIGS. 2 and 5, the partial area detecting unit 22 of the image processor 21 generates (51) differential data from data of a plurality of elasticity images.

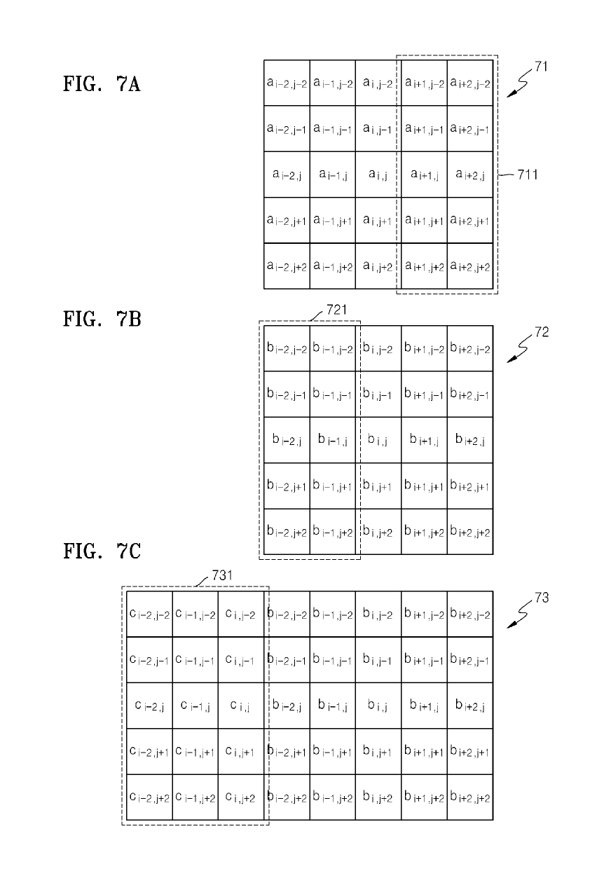

FIG. 7A is a diagram illustrating an example of data 71 of the first elasticity image 31 of FIG. 3. FIG. 7B is a diagram illustrating an example of data 72 of the second elasticity image 32 of FIG. 3. FIG. 7C is a diagram illustrating an example of data 73 of the third elasticity image 34 of FIG. 3 generated by combining the data 71 of the first elasticity image with the data 72 of the second elasticity image. Referring to the examples illustrated in FIGS. 3 and 7A through 7C, a plurality of pixels of the pieces of data 71 and 72 of the respective first and second elasticity images 31 and 32 have elasticity values. Partial areas 711 and 721 of the pieces of data 71 and 72 of the first and second elasticity images 31 and 32 correspond to the first and second partial areas 311 and 321 of the first and second elasticity images 31 and 32, respectively.

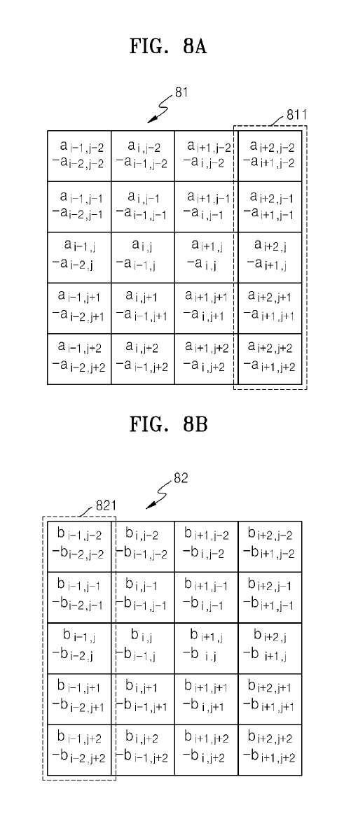

FIGS. 8A and 8B are diagrams illustrating examples of differential data 81 and 82 generated from the data 71 and 72 of FIGS. 7A through 7C of the first and second elasticity images 31 and 32 of FIG. 3, respectively. Referring to the examples illustrated in FIGS. 3, 7A through 7C, 8A, and 8B, the partial area detecting unit 22 generates the pieces of differential data 81 and 82 of the plurality of elasticity images by converting elasticity values of leftmost pixels into differential values between the elasticity values of the leftmost pixels and elasticity values of adjacent pixels for the pieces of data 71 and 72 of the first and second elasticity images 31 and 32, respectively.

Referring further to the examples illustrated in FIGS. 3, 5, 8A, and 8B, the partial area detecting unit 22 detects a first partial area 811 that is a portion of an examined area of the differential data 81 of the first elasticity image 31. In an example, the first partial area 811 is determined (52) based on a positional relationship between an examined area of the first elasticity image 31 and an examined area of the second elasticity image 32.

Referring further to the examples illustrated in FIGS. 3, 8A, 8B, and 9, when a medical expert diagnoses a disease of the patient 40 while moving the probe 11 rightward, the examined area of the second elasticity image 32 is located at the right of the examined area of the first elasticity image 31, and, thus, the partial area detecting unit 22 determines rightmost pixels B from pixels of the first elasticity image 31 as the first partial area 811. In an example of this case, the second elasticity image 32 refers to an image generated right after the first elasticity image 31 is generated.

On the contrary, when the medical expert diagnoses a disease of the patient 40 while moving the probe 11 leftward, the examined area of the second elasticity image 32 is located at the left of the examined area of the first elasticity image 31, and, thus, the partial area detecting unit 22 determines leftmost pixels A from pixels of the first elasticity image 31 as the first partial area 811. In addition, in an example, when the medical expert diagnoses a disease of the patient 40 while moving the probe 11 upward or downward, the examined area of the second elasticity image 32 is located at the top or bottom of the examined area of the first elasticity image 31, and, thus, the partial area detecting unit 22 determines uppermost pixels D or lowermost pixels C from the pixels of the first elasticity image 31 as the first partial area 811.

When the medical expert diagnoses a disease of the patient 40 while moving the probe 11, as shown in FIGS. 10A through 10C, the examined area of the second elasticity image 102 is located at the right and bottom of the first elasticity image 101, and, thus, the partial area detecting unit 22 determines right and lower four pixels 1011 from among pixels of the data 101 of the first elasticity image as the first partial area 811. In an example, a positional relationship between the examined area of the first elasticity image and the examined area of the second elasticity image is determined by a sensor provided in the probe 11. In an alternative example, a positional relationship between the examined area of the first elasticity image and the examined area of the second elasticity image is determined by analyzing image information of the first elasticity image and the second elasticity image.

Referring further to the examples illustrated in FIGS. 5, 8A, and 8B, the partial area detecting unit 22 detects (53) differential values of pixels of the determined first partial area 811 from among differential values of pixels of the differential data 81 of the first elasticity image as feature values. In an example, the feature values are expressed with feature vectors including the differential values of the pixels of the first partial area 811 as shown in Equation 1 below.

The partial area 22 detects (54) a second partial area 821 corresponding to the determined first partial area 811 of the differential data 81 of the first elasticity image from among an examined area of the differential data 82 of the second elasticity image based on a similarity between the differential values of the pixels of the determined first partial area 811 from among the pixels of the differential data 81 of the first elasticity image and differential values of pixels of the differential data 82 of the second elasticity image.

In an example of this case, the partial area detecting unit 22 detects an area having a greatest similarity to feature values of the differential values of pixels of the determined first partial area 811 of the differential data 81 of the first elasticity image as the second partial area 821 of the second elasticity image corresponding to the first partial area 811 of the first elasticity image by setting a moving window having the same matrix size as the pixels of the determined first partial area 811 of the differential data 81 of the first elasticity image to the pixels of the differential data 82 of the second elasticity image.

In an example, the partial area detecting unit 22 detects as the second partial area 821 of the second elasticity image a partial area of the differential data 82 of the second elasticity image when errors between differential values of pixels of the first partial area 811 of the differential data 81 of the first elasticity image and differential values of pixels of the partial area of the differential data 82 of the second elasticity image are obtained and a sum of the errors is minimal and equal to or less than a preset allowance error. In another example, if the sum of the errors between the differential values of the pixels of the first partial area 811 of the differential data 81 of the first elasticity image and the differential values of the pixels of the partial area of the differential data 82 of the second elasticity image exceeds an allowance range, the partial area detecting unit 22 searches for another area in the second elasticity image within the allowance range by moving to new coordinates.

In the detection of a stress distribution in a subject, free-hand elastography, which is a currently used elasticity imaging technique, enables a user to use the technique by directly applying non-uniform force with a probe, but, In an example, detecting a partial area of a second elasticity image based on feature values of differential values between elasticity values of elasticity images reduces the risk of false detection of the partial area due to a change in the size of a force applied when a first elasticity image and the second elasticity image are measured.

That is, although elasticity values of partial areas of different elasticity images vary in an example to an extent with respect to compression or relaxation of a probe when a medical expert diagnoses a disease, since elasticity values of adjacent tissues in a human body do not change abruptly and are kept constant, the elasticity values are strong against a change in an extent to which the probe compresses and relaxes. In this regard, in another example, when differential values of elasticity values are used as feature values, although elasticity values of a first elasticity image and a second elasticity image change, since differential values of elasticity values of adjacent pixels in the first elasticity image are similar to differential values of elasticity values of adjacent pixels in the second elasticity image, the risk of false detection of a partial area due to a difference between elasticity values of the first elasticity image and the second elasticity image is reduced.

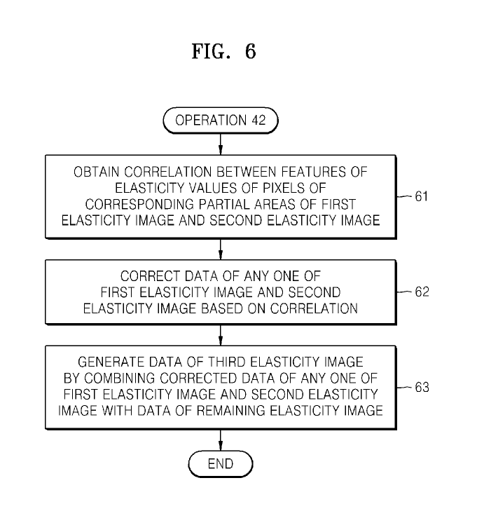

FIG. 6 is a flowchart an example of the generation of third elasticity image data according to the method of generating the elasticity image of FIG. 4. Referring to the examples illustrated in FIGS. 6 and 7A through 7C, the correcting unit 23 of the image processor 21 obtains (61) a correlation between features of elasticity values of pixels of the corresponding first and second partial areas 711 and 721 of the data 71 of the first elasticity image and the data 72 of the second elasticity image, respectively. In an example of this case, the correcting unit 23 obtains an average of the elasticity values of the pixels of the first partial area 711 of the data 71 of the first elasticity image and an average of the elasticity values of the pixels of the second partial area 721 of the data 72 of the second elasticity image, and obtains a correlation from a ratio of the averages of the pixels of the first and second partial areas 711 and 721 of the pieces of data 71 and 72 of the first and second elasticity images as shown in Equation 1.

$$W = \frac{\sum {b}_{ij}}{\sum {a}_{ij}} . \qquad ( 1 )$$

In Equation 1, W denotes a correlation, Σbᵢⱼ denotes a sum of the elasticity values of the pixels of the second partial area 721 of the data 72 of the second elasticity image, and Σaᵢⱼ denotes a sum of the elasticity values of the pixels of the first partial area 711 of the data 71 of the first elasticity image.

The correcting unit 23 corrects (62) any one of the data 71 of the first elasticity image and the data 72 of the second elasticity image based on the obtained correlation between the first partial area 711 of the data 71 of the first elasticity image and the second partial area 721 of the data 72 of the second elasticity image. In an example, when the second elasticity image is set to a main image and the first elasticity image is set to a sub-image, the correcting unit 23 corrects the data 71 of the first elasticity image. On the contrary, in another example, when the first elasticity image is set to a main image and the second elasticity image is set to a sub-image, the correcting unit 23 corrects the data 71 of the second elasticity image.

In FIGS. 7A through 7C, the correcting unit 23 corrects the data 71 of the first elasticity image which is a sub-image from among the first elasticity image and the second elasticity image according to Equation 2.

cᵢⱼ=W·aᵢⱼ (2)

In Equation 2, cᵢⱼ denotes corrected data obtained from the data 71 of the first elasticity image, W denotes a correlation, and aᵢⱼ denotes the data 71 of the first elasticity image. In an example of this case, the correcting unit 23 corrects elasticity values of all pixels included in the data 71 of the first elasticity image based on a correlation between the first partial area 711 of the data 71 of the first elasticity image and the second partial area 721 of the data 72 of the second elasticity image, or elasticity images of pixels of areas other than the first partial area from among the data 71 of the first elasticity image based on a correlation between the first partial area 711 of the data 71 of the first elasticity image and the second partial area 721 of the data 72 of the second elasticity image.

The combining unit 24 generates (63) the data 73 of the third elasticity image by combining the data 72 of the second elasticity image with the corrected data obtained from the data 71 of the first elasticity image. The data 73 of the third elasticity image is generated by combining a corrected area 731 obtained from areas other than the first partial area 711 of the data 71 of the first elasticity image with the second partial area 721 and a right area from among the data 72 of the second elasticity image.

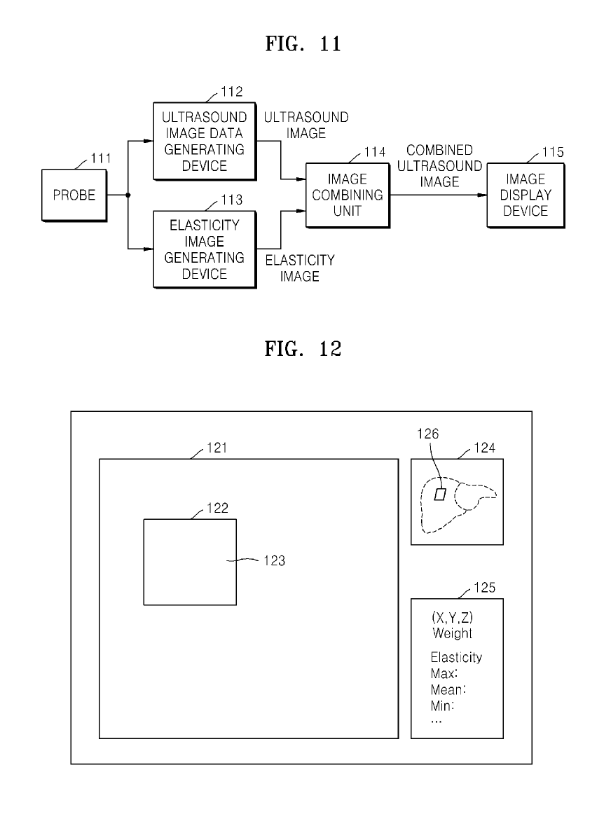

FIG. 11 is a block diagram illustrating another example of an elasticity imaging system. Referring to the example illustrated in FIG. 11, the elasticity imaging system includes an elasticity image generating device 113, an ultrasound image data generating device 112, and an image combining unit 114. The elasticity image generating device 113 is the same in configuration as the elasticity image generating device 20 of FIG. 1, and thus a repeated explanation thereof will not be given. In an example, the ultrasound image data generating device 112 generates brightness (B)-mode ultrasound image data. In another example, the image combining unit 114 generates a combined ultrasound image by combining the B-mode ultrasound image data generated by the ultrasound image data generating device 112 with third elasticity image data generated by the elasticity image generating device 113.

In a further example, the imaging system may includes a transmission/reception unit configured to separately transmit and receive a B-mode image signal configured to generate a B-mode ultrasound image and an elasticity image signal configured to generated an elasticity image. In an additional example, the B-mode ultrasound image is generated by performing B-mode processing such as logarithmic compression or envelope detection on data of a response signal obtained from a probe. The B-mode processing is obvious to one of ordinary skill in the art, and thus a detailed explanation thereof will not be given.

FIG. 12 is a block diagram illustrating an example of an ultrasound image obtained by the image combining unit 114 and displayed on the image display device 115. Referring to the example illustrated in FIG. 12, third elasticity image data is displayed in an elasticity image display area 122 in a B-mode ultrasound image data display area 121. In a display area 124, an overall shape of an organ and a position of an elasticity image in the organ are displayed, and, in a display area 125, maximum, minimum, and mean values of elasticity values of elasticity images are displayed. In an example, a position of an elasticity image is detected from a position of a probe. In another example, the position of the probe is obtained by performing triangulation based on an intensity of an electric wave between peripheral reference points such as end points of an organ or the probe, or from spatial position information obtained based on an acceleration sensor or a position sensor attached to the probe.

The units described herein may be implemented using hardware components and software components, such as, for example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors. As used herein, a processing device configured to implement a function A includes a processor programmed to run specific software. In addition, a processing device configured to implement a function A, a function B, and a function C may include configurations, such as, for example, a processor configured to implement both functions A, B, and C, a first processor configured to implement function A, and a second processor configured to implement functions B and C, a first processor to implement function A, a second processor configured to implement function B, and a third processor configured to implement function C, a first processor configured to implement functions A and B, and a second processor configured to implement function C, a first processor configured to implement functions A, B, C, and a second processor configured to implement functions A, B, and C, and so on.

The software components may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. For example, the software and data may be stored by computer readable recording media. Computer readable recording media may include any data storage device that can store data which can be thereafter read by a computer system or processing device. Examples of computer readable recording media include read-only memory (ROM), random-access memory (RAM), CD-ROMs, magnetic tapes, floppy disks, optical data storage devices. In addition, functional programs, codes, and code segments that accomplish the examples disclosed herein can be easily construed by programmers skilled in the art to which the examples pertain based on and using the flow diagrams and block diagrams of the figures and their corresponding descriptions as provided herein.

Program instructions to perform a method described herein, or one or more operations thereof, may be recorded, stored, or fixed in computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as that which is produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Further, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of generating an elasticity image, the method comprising:
detecting corresponding partial areas from examined areas of a first elasticity image and a second elasticity image from among a plurality of elasticity images indicating elasticity of examined areas in a subject; and
generating data of a third elasticity image, comprising combining data of the first elasticity image with data of the second elasticity image based on the corresponding partial areas of the first elasticity image and the second elasticity image.

2. The method of claim 1, wherein the detecting of the corresponding partial areas comprises detecting a feature value of a first partial area that is a portion of the examined area of the first elasticity image from the data of the first elasticity image, and detecting a second partial area corresponding to the first partial area from the examined area of the second elasticity image based on the detected feature value of the first partial area.

3. The method of claim 2, wherein the detecting of the feature value comprises converting elasticity values of pixels of the first elasticity image into differential values between the elasticity values of the pixels of the first elasticity image and elasticity values of adjacent pixels, and detecting differential values of pixels of the first partial area of the first elasticity image from among differential values of the pixels of the first elasticity image as feature values.

4. The method of claim 2, wherein the detecting of the second partial area is based on the detected feature value of the first partial areas and a similarity of the second elasticity image.

5. The method of claim 2, wherein the first partial area is determined based on a positional relationship between the examined area of the first elasticity image and the examined area of the second elasticity image.

6. The method of claim 1, wherein the detecting of the corresponding partial areas comprises converting elasticity values of pixels of the plurality of elasticity images into differential values to generate differential data of the plurality of elasticity images, detecting differential values of pixels of a first partial area that is a portion of the examined area of the first elasticity image from differential data of the first elasticity image as feature values, and detecting an area having a greatest similarity to a feature value of the first partial region from differential data of the second elasticity image as a second partial area of the second elasticity image corresponding to the first partial area of the first elasticity image.

7. The method of claim 6, wherein a partial area of the differential data of the second elasticity image that allows a sum of errors between differential values of pixels of the first partial area from among the differential data of the second elasticity image and differential values of pixels of the partial area of the differential data of the second elasticity image to be equal to or less than a preset allowance error is detected as the second partial area.

8. The method of claim 1, wherein the first elasticity image is combined with the second elasticity image by matching pixels of the corresponding partial areas of the first elasticity image and the second elasticity image to generate the data of the third elasticity image.

9. The method of claim 8, wherein the generating of the data of the third elasticity image comprises correcting the data of any one of the first elasticity image and the second elasticity image based on a correlation between features of the corresponding partial areas of the first elasticity image and the second elasticity image to obtain corrected data, and combining the corrected data obtained from any one of the first elasticity image and the second elasticity image with the data of an elasticity image that remains from the any one of the first elasticity image and the second elasticity image.

10. The method of claim 9, wherein the correcting of the data of any one of the first elasticity image and the second elasticity image is based on a correlation obtained between features of elasticity values of pixels of the corresponding partial areas of the first elasticity image and the second elasticity image.

11. The method of claim 10, wherein the correlation between the features of the elasticity values of the pixels of the corresponding partial areas of the first elasticity image and the second elasticity image is obtained from a ratio of analyzed averages of the elasticity values of the pixels of the corresponding partial areas of the first elasticity image and the second elasticity image.

12. The method of claim 1, wherein the generated data of the third elasticity image indicates elasticity of an examined area including the examined area of the first elasticity image and the examined area of the second elasticity image.

13. The method of claim 1, further comprising:
determining a position of an examined area of the third elasticity image in all areas of an elasticity image display device; and
displaying the position of the examined area of the third elasticity image on the elasticity image display device.

14. An elasticity image generating apparatus, comprising:
an image processor configured to detect corresponding partial areas from examined areas of a first elasticity image and a second elasticity image from among a plurality of elasticity images indicating elasticity of examined areas in a subject, and generate data of a third elasticity image by combining data of the first elasticity image with data of the second elasticity image based on the corresponding partial areas of the first elasticity image and the second elasticity image.

15. The apparatus of claim 14, further comprising:
a storage unit configured to store therein information configured to detect the corresponding partial areas of the first elasticity image and the second elasticity image.

16. The apparatus of claim 14, wherein the image processor comprises a partial area detecting unit, a correcting unit, and a combining unit, the partial area detecting unit being configured to detect a feature value of a first partial area that is a portion of the examined area of the first elasticity image from the data of the first elasticity image, the partial area detecting unit being configured to detect a second partial area corresponding to the first partial area from the examined area of the second elasticity image based on the detected feature value of the first partial area, the correcting unit being configured to correct the data of any one of the first elasticity image and the second elasticity image based on a correlation between features of the corresponding partial areas of the first elasticity image and the second elasticity image to obtain corrected data, the combining unit being configured to combine the corrected data obtained from any one of the first elasticity image and the second elasticity image with the data of an elasticity image that remains from the any one of the first elasticity image and the second elasticity image.

17. The apparatus of claim 16, wherein the partial area detecting unit is further configured to convert elasticity values of pixels of the first elasticity image into differential values between the elasticity values of the pixels of the first elasticity image and elasticity values of adjacent pixels, and detect differential values of pixels of the first partial area of the first elasticity image from among differential values of the pixels of the first elasticity image as feature values.

18. The apparatus of claim 16, wherein the partial area detecting unit is further configured to detect as the second partial area of the second elasticity image a partial area of differential data of the second elasticity image that allows a sum of errors between differential values of pixels of the first partial area from among the differential data of the second elasticity image and differential values of pixels of the partial area of the differential data of the second elasticity image to be equal to or less than an allowance error.

19. The apparatus of claim 16, wherein the correcting unit is further configured to correct the data of any one of the first elasticity image and the second elasticity image based on a correlation obtained by the correcting unit, the correlation being between features of elasticity values of pixels of the corresponding partial areas of the first elasticity image and the second elasticity image.

20. The apparatus of claim 14, further comprising:
an ultrasound image data generating unit configured to generate brightness (B)-mode ultrasound image data; and
an image combining unit configured to combine the B-mode ultrasound image data with the data of the third elasticity image to generate a combined ultrasound image.

21. A computer-readable recording medium having embodied thereon a program configured to execute a method of generating an elasticity image, the method comprising:
detecting corresponding partial areas from examined areas of a first elasticity image and a second elasticity image from among a plurality of elasticity images indicating elasticity of examined areas in a subject; and
generating data of a third elasticity image, comprising combining data of the first elasticity image with data of the second elasticity image based on the corresponding partial areas of the first elasticity image and the second elasticity image.

22. A method of generating an elasticity image, comprising:
detecting corresponding first and second partial areas based on data of a first elasticity image indicating elasticity of a first examined area in a subject and data of a second elasticity image indicating elasticity of a second examined area in the subject, the first partial area being a portion of an examined area of the first elasticity image, the second partial area being a portion of an examined area of the second elasticity image; and
generating data of a third elasticity image, comprising combining the data of the second elasticity image with data of a corrected image obtained from the data of the first elasticity image.
